(19) United States
(12) Patent Application Publication
(10) Pub. No.: US 2012/0089501 A1
(43) Pub. Date: Apr. 12, 2012

(54) Method for Sharing Ownership and Revenue with Customers

(75) Inventor: Sharath Vaddempudi, Irving, TX (US)

(73) Assignee: Sharath Vaddempudi, Irving, TX (US)

(21) Appl. No.: 12/901,545

(22) Filed: Oct. 10, 2010

(51) Int. Cl. G06Q 40/00

(52) U.S. Cl. 705/37

(57) ABSTRACT

A new ownership and revenue sharing method where the customers have an opportunity to gain part ownership of the business, nurturing competition among the customers. In this method, Native Owners are the actual owners and/or stakeholders who have all the rights and initial majority of ownership. This could be the Founders, Investors and other primary stakeholders. The customers as a group would become the Secondary Stakeholders in the business. The total percentage of ownership given or dedicated or declared to the customers is at the discretion of the Native Owners/Primary Stakeholders. The maximum allowable secondary ownership is defined by the Primary stakeholders.

Customers could earn ownership in the business with/without having to purchase any goods or services. The size of the secondary ownership distributed to the customers is to the discretion of the Native Owners and also depends on the business, the industry and other factors.

### CROSS REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to sharing the ownership and revenue of a business entity among its customers.

### BACKGROUND OF THE INVENTION

In recent years the variety of Customer Acquisition & Retention Programs has been growing exponentially. Fierce competition between businesses has partly led to this.

Major priority for most businesses is to attract new customers while retaining old customers. A new business method to do this is by offering them part ownership of the business.

To further nurture customer competition, a customer's stake could be relative to other customers. While they buy, use or engage themselves through the offerings of a business, they could also own a part of the business.

Customers could help further grow the business by actively engaging in the business operations and proactively providing useful feedback to improve the business as it exists.

The challenge with retaining customers is more acute in businesses that offer services/products which customers don't need to necessarily purchase.

### SUMMARY OF THE INVENTION

There exists a dearth for ownership and revenue sharing methods aimed at customers who may/may not have to purchase goods or services from the business. This invention, referred to herein as “Ownership and Revenue Sharing Method” offers a new approach to acquiring and retaining customers to an extent that other methods have not realized.

A customer could earn part ownership by only participating without the need to purchase any goods or services.

Each customer owns a stake in relation to the criteria and guidelines based on which the secondary ownership is distributed.

The maximum allowable secondary ownership is at the discretion of the Primary stakeholders.

The Ownership and Revenue Sharing Method has many advantages, both for businesses as well as for the participating customers.

One advantage of letting the Primary stakeholders capping the maximum allowable Secondary ownership is that it ensures the interest and stake of the Primary owners.

Customers are ensured a stake up to the maximum allowable limit set by the Primary owners.

Another advantage of the Ownership and Revenue Sharing method for both the business and the customers is that it nurtures competition between the customers to gain a larger stake thus improving the value of the business to all stakeholders.

With this Ownership and Revenues Sharing method, customers have the opportunity to be involved in the promotion and potentially even in the operations of the business.

Businesses have the opportunity to gain feedback and new ideas from the customer's perspective.

The Ownership and Revenue Sharing method can be implemented in a variety of ways by the Primary stakeholders, including but not limited to, security instruments, points systems, or credit systems.

### BRIEF DESCRIPTION OF THE DRAWINGS

The foregoing and other features of the present invention will be more readily apparent from the following detailed description and drawings of illustrative embodiments of invention in which:

FIG. 1 is a depiction of the allocation of maximum allowable secondary ownership by the Primary stakeholders of the business to the customers of the business

FIG. 2 is a flowchart of generic business process exemplifying the new ownership and revenue sharing method that is the present invention.

### DETAILED DESCRIPTION OF THE INVENTION

The aspects of the invention will now be described in more detail in connection with a number of exemplary embodiments.

The present invention provides a method for nurturing healthy competition among the customers of a business by fixing the maximum allowable secondary stake in the business and the guidelines and criteria based on which the secondary ownership in the business is distributed with/without needing to make purchases. This invention of Ownership and Revenue Sharing method will now be described in detail with reference to the drawings, so as to enable those skilled in the art to practice the invention.

Use of the term “Primary Owners” or “Primary Stakeholders” refers to the group of stakeholders who have all the rights and initial ownership majority. Use of the term “Secondary Ownership” refers to the portion of ownership distributed to the customers. Use of the term “Customer” refers to any legal entity, whether individual or corporate, registered to the business. Use of the term “Business” refers to any corporation, whether private or public.

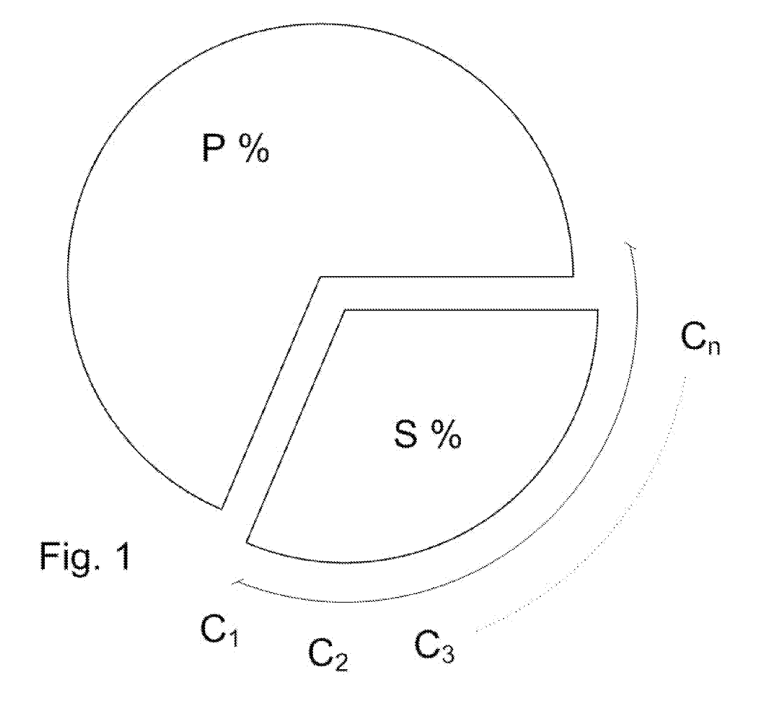

FIG. 1 depicts the conceptual theme of setting the maximum allowable secondary ownership (S %) that is to be distributed among all customers (C1, C2, . . . Cn) based on their criteria and guidelines established by the Primary Stakeholders. The primary ownership is depicted by P %.

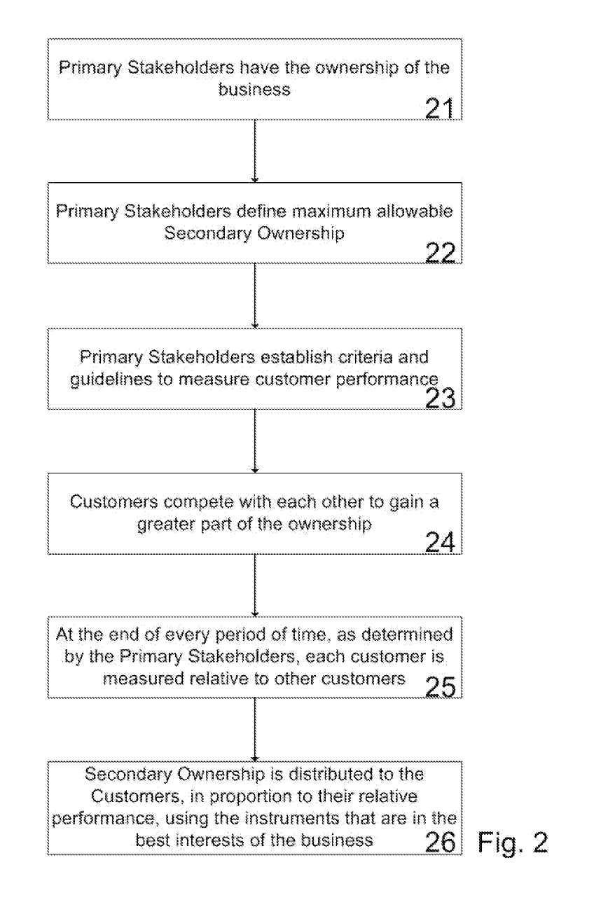

FIG. 2 highlights the steps involved in the present invention. The Primary Stakeholders have the ownership of the organization in step 21 and have it registered either as a Private or Public Company. The Primary Stakeholders then define the maximum allowable Secondary Ownership in step 22 that the entire group of customers of the business is permitted to receive as a whole. The Primary Stakeholders establish the guidelines to measure the level of customer performance in step 23. Once these initial ground rules are set up, Customers can register with the business and compete with each other, in order to gain a greater part of the ownership in step 24. At the end of every time period as determined by the Primary Stakeholders, each customer is measured relative to other customers in step 25. Secondary ownership is distributed to the customers in proportion to their relative performance using instruments that are in the best interest of their business in step 26.

Consider a scenario where a grocery store is set up by a group of people, who are termed as the Primary Stakeholders since they hold the majority ownership of the store in step 21. In this case, the Primary Stakeholders own 100% of the grocery store. Using the Revenue Sharing and Customer Ownership method, they can set aside a certain percentage of the store ownership to their customers lets say, 40% in step 22. This 40% can be divided among the store's customers based on criteria devised by the Primary Stakeholders in step 23. As the store gains more customers, the 40% of customer ownership keeps diluting with a high probability that the value of the ownership of each customer keeps growing as business grows with new and a more loyal customer base. To quantify the criteria, a business could use their own techniques and analysis best suited for them. The value of the ownership could be diluted based on the customer competitiveness and the new customers joining the ownership program.

Another embodiment may contemplate a similar scenario for a different kind of business. A social networking web site is launched by a group with a few investors and partners, together called the Primary Stakeholders, as they hold 100% of the stake in the business. They can follow the Method for Sharing Ownership and Revenue with Customers and decide to offer 30% of their stake to their customers. Now the Primary Stakeholders own only 70% of the business. To quantify the criteria, the Primary Stakeholders use a technique/algorithm best suited for their business. The value of the stake could be diluted based on the customer competitiveness and the new customers joining the ownership program.

While the invention has been particularly shown and described with reference to preferred embodiments thereof, it will be understood by those skilled in the art that various changes in form and details may be made therein without departing from the spirit and scope of the invention.

What is claimed is:

1. A method for sharing Ownership and Revenue with customers by providing them with a stake in the business, the method comprising of:
establishing a coupled relationship between the Primary Stakeholders who have all the rights and majority of initial ownership, and the Customers who receive the Secondary Ownership;
distributing part ownership to the customers in the form of Secondary ownership;
defining the maximum allowable Secondary ownership by the Primary stakeholders;
obtaining Secondary ownership with or without the need to purchase goods and/or services offered by the Business;
nurturing competition among the customers of the Business;

2. The method of claim 1, wherein the Businesses whose Secondary ownership and Revenue is distributed is a Public Company.

3. The method of claim 1, wherein the criteria for distributing Secondary ownership and Revenue is defined by the Primary stakeholders.

4. The method of claim 1, wherein the initial criteria set for the distribution of Secondary ownership and Revenue is modified by the Primary stakeholders

5. The method of claim 1, wherein the initial criteria set for the distribution of Secondary ownership and Revenue is modified by the Primary and Secondary stakeholders together.

6. The method of claim 1, wherein the Businesses whose Secondary ownership and Revenue is distributed is a Private Firm

7. The method of claim 1, wherein Secondary ownership and Revenue is distributed in the form of Stock.

8. The method of claim 1, wherein Secondary ownership and Revenue is distributed in the form of Warrants or Stock Options.

9. The method claim 1, wherein Secondary ownership and Revenue is distributed in the form of Bonds.

10. The method of claim 1, wherein Secondary ownership and Revenue is distributed in the form of Convertible Bonds.

11. The method of claim 1, wherein Secondary ownership and Revenue is distributed in the form of points that are redeemable with the Business.
